(19) United States
(12) Patent Application Publication
(10) Pub. No.: US 2011/0124225 A1
(43) Pub. Date: May 26, 2011

(54) ELECTRICAL CONNECTOR ASSEMBLY HAVING SHIELDING COVER WITH IMPROVED CASING PORTION

(75) Inventor: JUN ZHOU, Shenzhen (CN)

(73) Assignee: HON HAI PRECISION INDUSTRY CO., LTD., Tu-Cheng (TW)

(21) Appl. No.: 12/954,657

(22) Filed: Nov. 25, 2010

(30) Foreign Application Priority Data
Nov. 25, 2009 (CN) 200920315738.1

(51) Int. Cl. H01R 13/648

(52) U.S. Cl. 439/607.01

(57) ABSTRACT

An electrical connector assembly (100) includes an insulative housing (1), a plurality of contacts (2) assembled in the insulative housing, a metal cover (3) shielding the insulative housing, and a cable (5) having a number of wires connected with the contacts. The insulative housing includes a base portion (11) and a tongue portion (12) integral with the base portion. The insulative housing defines a mating direction. The metal cover includes a casing portion (312) having an upper face (3121) and a lower face (3120) respectively at opposite sides of the tongue portion. The lower face forms a curved portion (314) protruding towards the upper face and a tail portion (315) integral with the curved portion such that the curved portion and the tail portion are situated between the lower face and the upper face. The tail portion engages the tongue portion along the mating direction such that the tail portion is supported by the tongue portion.

### CROSS-REFERENCE TO RELATED APPLICATIONS

This patent application relates to a U.S. patent application Ser. No. 12/913,806, filed on Oct. 28, 2010, entitled “ELECTRICAL CONNECTOR ASSEMBLY WITH IMPROVED CONTACT SOLDERING ENDS”, which is assigned to the same assignee as this application.

### BACKGROUND OF THE INVENTION

1. Field of the Invention

The present invention relates generally to an electrical connector assembly, and more particularly to a USB (Universal Serial Bus) connector assembly with contacts firmly retained in insulative housing for engaging a mating connector.

2. Description of Related Arts

Personal computers (PC) are widely used today. Universal Serial Bus (USB) is a serial bus standard to the PC architecture which focuses on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method. Furthermore, due to the need for high speed signal transmission of electronic products, USB 3.0 connectors have been adopted.

U.S. Patent Application Publication No. 2010/0112863 published on May 6, 2010 discloses a USB 3.0 connector. The USB 3.0 connector comprises an insulative body, a plurality of contacts received in the insulative body, and a metal shell covering the insulative body. The insulative body includes a backward part and a forward part integrally extending forwards from the backward part. The forward part comprises a narrow tongue and a wide tongue disposed in a common plane. The narrow tongue and the wide tongue are spaced a distance from each other at front ends thereof. The contacts comprise a plurality of first contacts received in the narrow tongue and a plurality of second contacts received in the wide tongue, respectively transmitting differential signals. Each contact comprises a contacting portion extending beyond an upper surface of the frontward part of the insulative housing and a soldering portion extending out of the backward part and thus exposed outside the insulative housing. The forward part has quite a large length in a front-to-rear direction such that it may droop down and the contacting portions of the contacts inserted from the backward part to the forward part may rise up relative to the lowered forward part. The USB 3.0 connector further comprises a pair of latches assembled at two sides of the second contacts, and the latches also may rise up relative to the lowered forward part because the forward part droops down. Therefore, the contacts and the latches will hinder insertion of a mating connector. The contacts may even be pushed out of the insulative body if a large insertion force is exerted.

Hence, an electrical connector assembly with improved shell to alleviate drooping down of the forward part of the insulative housing is desired.

### SUMMARY OF THE INVENTION

Accordingly, an object of the present invention is to provide an electrical connector assembly with improved shell to alleviate dropping down of the forward part of the insulative housing.

To achieve the above object, an electrical connector assembly includes an insulative housing, a plurality of contacts assembled in the insulative housing, a metal cover shielding the insulative housing, and a cable having a number of wires connected with the contacts. The insulative housing includes a base portion and a tongue portion integral with the base portion. The insulative housing defines a mating direction. The metal cover includes a casing portion having an upper face and a lower face respectively at opposite sides of the tongue portion. The lower face forms a curved portion protruding towards the upper face and a tail portion integral with the curved portion such that the curved portion and the tail portion are situated between the lower face and the upper face. The tail portion engages the tongue portion along the mating direction such that the tail portion is supported by the tongue portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical connector assembly constructed in accordance with the present invention;

FIG. 2 is a perspective, partly assembled view of the electrical connector assembly when an insulative cover and a cable are not shown;

FIG. 3 is a perspective, fully exploded view of FIG. 2;

FIG. 4 is another fully exploded view similar to FIG. 3 but taken a different aspect; and

FIG. 5 is a cross-sectional view of the electrical connector assembly taken along line 5-5 of FIG. 2.

### DETAILED DESCRIPTION OF THE PREFERRED EMBODIMENT

Reference will now be made in detail to the preferred embodiment of the present invention.

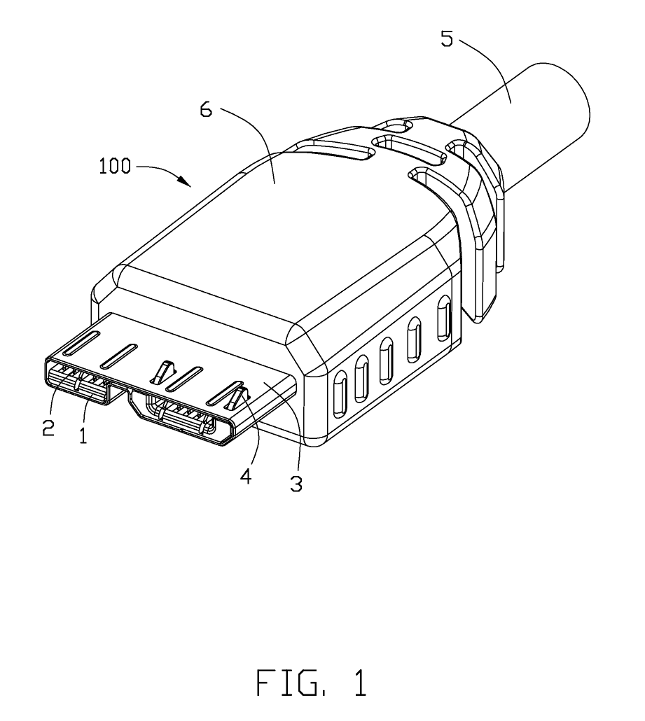

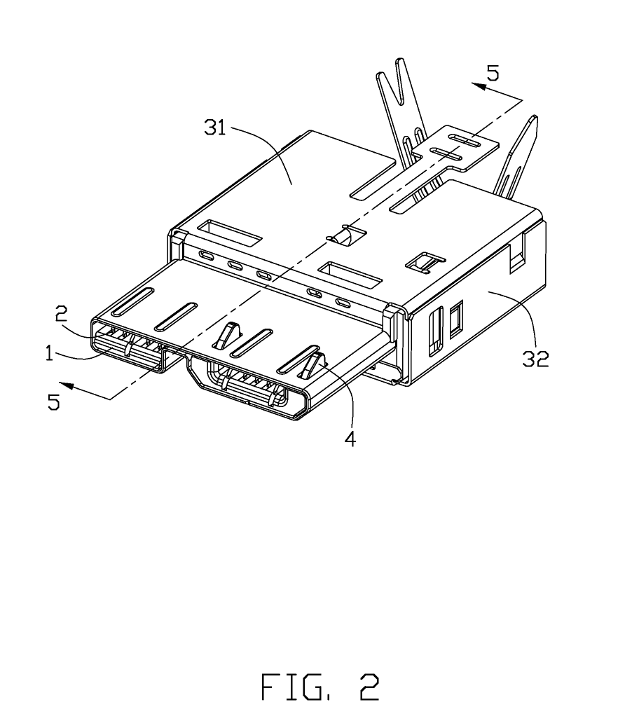

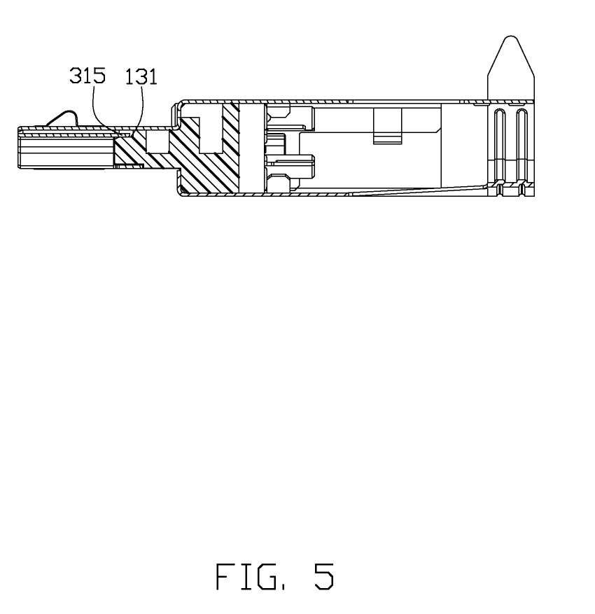

Referring to FIGS. 1-5, a USB 3.0 connector assembly 100 in accordance with the present invention used for transmitting high speed differential signals, comprises an insulative housing 1, a plurality of contacts 2 and a pair of latches 4 assembled in the insulative housing 1, a shield 3 covering the insulative housing 1, a cable 5 connecting with the contacts 2, and an insulative cover 6 partly molding outside of the shield 3 and the cable 5.

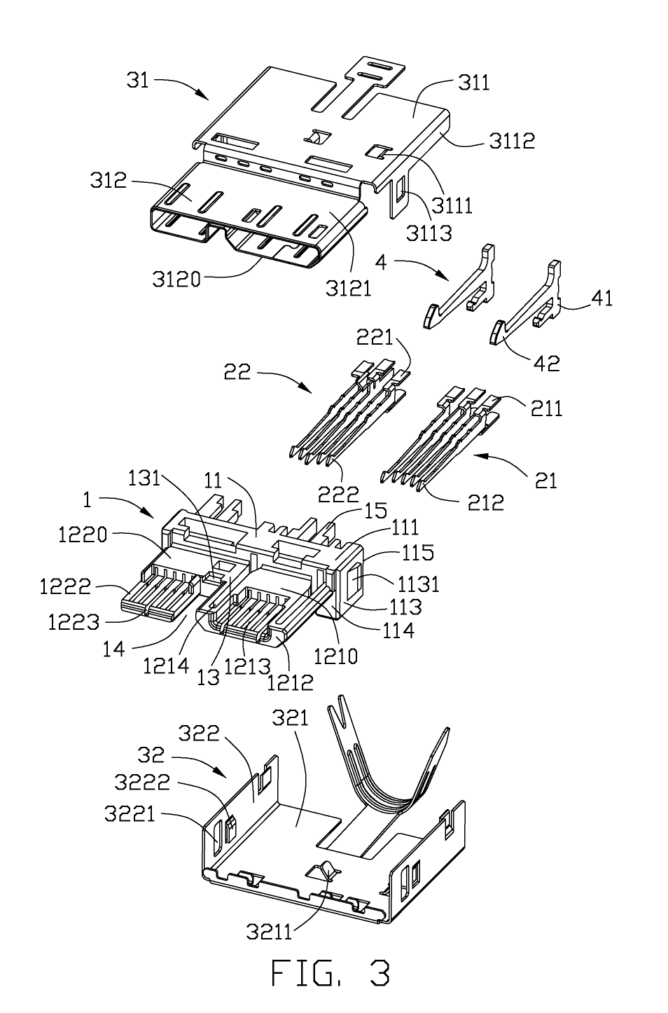

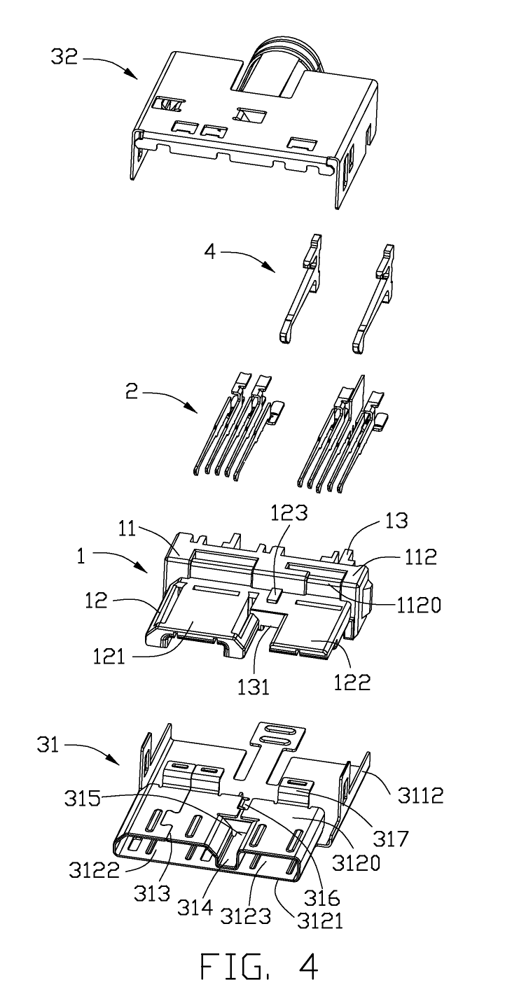

Referring to FIGS. 3-4, the insulative housing 1 comprises a base portion 11 and a tongue portion 12 extending forwardly from the base portion 11. The tongue portion 12 is arranged lower than the base portion 11 for facilitating connection with a mating connector (not shown) along a mating direction. The base portion 11 extends along a transverse direction perpendicular to the mating direction. The base portion 11 defines an upper surface 111, a lower surface 112 opposite to the upper surface 111, a pair of side surfaces 113 connecting with the upper surface 111 and the lower surface 112, a front surface 114 from which the tongue portion 12 extends, and a rear surface 115 opposite to the front surface 114. Each side surface 113 forms a protrusion 1131. The tongue portion 12 comprises a first, wide mating tongue 121 and a second, narrow mating tongue 122 arranged at a same level as the first, wide mating tongue 121. The first, wide mating tongue 121 comprises a first connecting portion 1210 integral with the base portion 11 and a first mating portion 1212 integrally, forwardly extending from the first connecting portion 1210. Correspondingly, the second, narrow mating tongue 122 comprises a second connecting portion 1220 integral with the base portion 11 and a second mating portion 1222 integrally, forwardly extending from the second connecting portion 1220. An interspace 14 is defined between the first mating portion 1212 and the second mating portion 1222. The first connecting portion 1210 integrates with the second connecting portion 1220 at a jointing portion 13 for increasing intensity of the tongue portion 12. A stepped portion 131 is formed at the front of the jointing portion 13. The first mating tongue 121 defines a plurality of first passageways 1213 and the second mating tongue 122 defines a plurality of second passageways 1223. The first passageways 1213 and the second passageways 1223 extend through the insulative housing 1 along the mating direction and backwardly end at the rear surface 115 of the base portion 11. Additionally, the first mating tongue 121 defines a pair of slots 1214 at two sides of the first passageways 1213 for receiving the latches 4. The base portion 10 forms a plurality of ribs 15 extending rearward from the rear surface 115 along the mating direction. The ribs 15 and the tongue portion 12 are located at opposite sides of the base portion 11.

Referring to FIGS. 3-4, the contacts 2 have a group of first terminals 21 which are assembled in the first tongue portion 121 of the insulative housing 1 and a group of second terminals 22 which are assembled in the second tongue portion 122 of the insulative housing 1. Each of the first terminal 21 and the second terminal 22 has a soldering portion 211/221 and a contacting portion 212/222 at front of the soldering portion 211/221. The contacts 2 are received in the corresponding passageways 1213, 1223 of the insulative housing 1 and the contacting portions 212, 222 extend beyond the mating portions 1212, 1222 for engaging with the mating connector, while the soldering portions 211, 221 extend out of the base portion 1 from the rear surface 115 for connecting with the cable 5. Each contacting portion 212/222 extends in a vertical plane while the soldering portions 211/221 alternately bend upwardly or downwardly from the corresponding contacting portions 212/222. The soldering portions 211, 221 extend in parallel, horizontal planes. The ribs 13 divide the soldering portions 211, 221 one from the other and the soldering portions 211, 221 are leaned against the adjacent ribs 13.

Referring to FIG. 3, each latch 4 comprises a retaining portion 41 and a locking portion 42 extending forward from the retaining portion 41. The latches 4 are both assembled in the slots 1214 of the first tongue portion 121. The latches 4 are disposed at opposite sides of the first contacts 21.

Referring to FIGS. 1-5, the shield 3 comprises a first, upper metal cover 31 and a second, lower metal cover 32 attached to the first, upper metal cover 31. The upper metal cover 31 comprises a flat portion 311 and a casing portion 312 extending from the flat portion 311. The casing portion 312 essentially covers the tongue portion 12. The lower metal cover 32 are attached to the flat portion 311 of the upper metal cover 31 and associates with the flat portion 311 for covering the base portion 11 of the insulative housing 1. The latches 4 projects upwardly out of the casing portion 312 of the shield 3 when assembled. The flat portion 311 of the upper metal cover 31 is stamped a pair of f flexural portions 3111 and the lower metal cover 32 is also stamped a pair of flexural portions 3211 for withstanding a rearward of the latches 4.

The casing portion 312 defines an upper face 3121 and a lower face 3120 opposite to the upper face 3121. The lower face 3120 protrudes towards the upper face 3121 and thereby, forms a curved portion 314 which divides the casing portion 312 into a first insertion space 3122 and a second insertion space 3123 for correspondingly and respectively receiving the first, wide mating tongue 121 and the second, narrow mating tongue 122. The lower face 3120 has a welding seam 313 at the lower of the first insertion space 3122. The welding seam 313 is situated at similarly one third width of the casing portion 312 and the curved portion 314 is situated at similarly another one third width of the casing portion 312. The curved portion 314 forms a tail portion 315 at a distal end along the mating direction. The tail portion 315 extends up to the tongue portion 12 and is supported by the jointing portion 13, in the preferred embodiment of the present invention, the tail portion 315 is supported by the stepped portion 131 as if the tongue portion 12 is raised up by the upper metal cover 31 such that the tongue portion 12 is prevented from drooping down, the contacts 2 and the latches are accordingly firmly retained in the tongue portion 12. Just along an up-and-down direction perpendicular to the mating direction, the lower face 3120 defines a cutout 316 at the rear thereof and the insulative housing 1 forms a block 123 at the lower side of the tongue portion 12. When the upper metal cover 31 shields over the insulative housing 1, the cutout 316 is guided by and receives the block 123 for correctly positioning the upper metal cover 31 and the insulative housing 1. The lower face 3120 forms a plurality of frames 317 and the insulative housing 1 defines a plurality of recesses 1120 at the base portion 11, and the frames 317 extend in the recesses 1120 for connecting the upper metal cover 31 and the insulative housing 1.

The upper metal cover 31 further comprises a pair of side walls 3112 extending downwardly from the flat portion 311 and at least one opening 3113 at each side wall 3112. The lower metal cover 32 comprises a main portion 321 and a pair of side portions 322 extending upwardly from the main portion 321. The side portion 322 defines a slit 3221 mating with the protrusion 1131 and forms a stamped portion 3222 beside the slit 3221 for engaging with the opening 3113 of the upper metal cover 31.

The cable 5 has a plurality of wires (not shown) respectively soldered to the contacts 2. The insulative cover 6 is partly molded outside of the shield 3 and the cable 5.

A manufacturing method of the electrical connector assembly 100 includes: providing an insulative housing 1 having a base portion 11 and a tongue portion 12 integral with the base portion 11; assembling a plurality of contacts 2 in the insulative housing 1; providing a metal cover 3 shielding the insulative housing 1; soldering a cable 5 with a plurality of wires on the contacts 2; molding an insulative cover 6 outside of the shield 3 and the cable 5. A manufacturing method of the metal cover 3 includes providing a metal piece 31 with a wide front part 312 and a narrow rear part 311; connecting two opposite edges of the wide front part into a casing portion 312, the casing portion 312 having an upper face 3121 connecting to the narrow rear part 311 and a lower face 3120 having a welding seam 313 at about one third width of the casing portion 312; and splitting the lower face 3120 at about two thirds width of a rear side of the casing portion 312, thus forming a tail portion 315 and a curved portion 314 protruding towards the upper face 3121 and a narrowed cutout 316. A second, lower metal cover 32 is also attached to the first, upper metal cover 31 for entirely shielding the insulative housing 1.

In the present invention, because the upper metal cover 31 comprises a tail portion 315 on the lower face 3120 and the tail portion 315 is supported by the stepped portion 131 of the tongue portion 12. The tongue portion 12 is raised up by the upper metal cover 31 such that the tongue portion 12 is prevented from drooping down, the contacts 2 and the latches 4 are accordingly firmly retained in the tongue portion 12. Accordingly, the mating connector is favorably, conveniently engaged with the USB 3.0 connector assembly 100 of the present invention.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector assembly comprising:
an insulative housing comprising a base portion and a tongue portion integral with the base portion, the insulative housing defining a mating direction;
a plurality of contacts assembled in the insulative housing;
a metal cover shielding the insulative housing, the metal cover comprising a casing portion having an upper face and a lower face respectively at opposite sides of the tongue portion, the lower face forming a curved portion protruding towards the upper face and a tail portion integral with the curved portion such that the curved portion and the tail portion are situated between the lower face and the upper face, the tail portion engaging the tongue portion along the mating direction such that the tail portion is supported by the tongue portion; and
a cable having a plurality of wires connected with the contacts.

2. The electrical connector assembly as claimed in claim 1, wherein the tongue portion comprises a first mating tongue and a second mating tongue respectively receiving different contacts, an interspace is defined between the first mating tongue and the second mating tongue, and the interspace receives the curved portion.

3. The electrical connector assembly as claimed in claim 2, wherein the first mating tongue and the second mating tongue connect with each other at a jointing portion adjacent to the base portion and the tail portion is supported by the jointing portion.

4. The electrical connector assembly as claimed in claim 2, wherein the curved portion divides the casing portion into a first insertion space and a second insertion space correspondingly and respectively receiving the first mating tongue and the second mating tongue.

5. The electrical connector assembly as claimed in claim 1, wherein the lower face defines a cutout, the insulative housing forms a block at the lower side of the tongue portion, and the block is received in the cutout.

6. The electrical connector assembly as claimed in claim 5, wherein the cutout is positioned below the tail portion along an up-and-down direction perpendicular to the mating direction.

7. The electrical connector assembly as claimed in claim 1, wherein the metal cover comprises a flat portion integral with the upper face, a main portion corresponding to the flat portion along an up-and-down direction perpendicular to the mating direction and a number of side walls connecting with the flat portion and the main portion for receiving the base portion.

8. An electrical connector comprising:
an insulative housing defining a commonly base with first and second mating tongues extending forwardly therefrom along a mating direction, said first and second mating tongues essentially spaced from each other with a gap in a transverse direction perpendicular to said mating direction;
a unitary metallic shell attached to the housing and enclosing both said first and second mating tongue with opposite top and bottom plates and opposite side plates essentially perpendicular to said opposite top and bottom plates, said shell defining a narrowed section which reduces a distance between the opposite top and bottom plates in a vertical direction perpendicular to both said mating direction and said transverse direction, and occupying said gap so as to cooperate with the corresponding first and second mating tongues to form respectively first and second mating ports thereof; wherein
in said narrowed section, the top plate and the bottom plate are essentially intimately overlapped with each other under condition that the bottom plate extends further rearwardly opposite to the mating direction from said narrowed section with a horizontal tab which is sandwiched between the top plate and the housing so as to reinforce the narrowed section.

9. The electrical connector as claimed in claim 8, wherein the housing defines a recess facing the top plate to receive said horizontal tab.

10. The electrical connector as claimed in claim 8, wherein said first and second mating tongues are joined with each other at a joint place around corresponding root sections with a distance along the mating direction under condition that said distance is only a portion of a full dimension of either one of said first and second mating tongues in said mating direction, and the recess and the corresponding horizontal tab are located in the root sections at said joint place.

11. The electrical connector as claimed in claim 10, wherein said shell further forms a seam structure which is dimensioned with and applied upon said joined mating tongues at said joint place.

12. The electrical connector as claimed in claim 11, wherein said horizontal tab cooperates with said seam structure to sandwich therebetween joined mating tongues at said joint place in said vertical direction.

13. The electrical connector as claimed in claim 11, wherein the shell further forms another seam structure on the bottom plate in alignment with one of the first and second mating tongues in said vertical direction.

14. The electrical connector as claimed in claim 13, wherein said another seam structure defines the full dimension of

15. The electrical connector as claimed in claim 10, wherein said joint place is aligned with and located behind the gap in said mating direction.

16. An electrical connector comprising:
an insulative housing defining a commonly base with first and second mating tongues extending forwardly therefrom along a mating direction, said first and second mating tongues essentially spaced from each other with a gap in a transverse direction perpendicular to said mating direction;
a unitary metallic shell attached to the housing and enclosing both said first and second mating tongue with opposite top and bottom plates and opposite side plates essentially perpendicular to said opposite top and bottom plates, said shell defining a narrowed section which reduces a distance between the opposite top and bottom plates in a vertical direction perpendicular to both said mating direction and said transverse direction, and occupying said gap so as to cooperate with the corresponding first and second mating tongues to form respectively first and second mating ports thereof; wherein
in said narrowed section, the top plate and the bottom plate are essentially intimately overlapped with each other under condition that the bottom plate extends further rearwardly opposite to the mating direction from said narrowed section with a horizontal tab; wherein
said first and second mating tongues are joined with each other at a joint place around corresponding root sections with a distance along the mating direction under condition that said distance is only a portion of a full dimension of either one of said first and second mating tongues in said mating direction, and the corresponding horizontal tab are located in the root sections at said joint place.

17. The electrical connector as claimed in claim 16, wherein said shell further forms a seam structure applied upon said joined mating tongues at said joint place.

18. The electrical connector as claimed in claim 17, wherein said seam structure is essentially aligned with the horizontal tab in the vertical direction.

19. The electrical connector as claimed in claim 18, wherein the shell further forms another seam structure on the bottom plate in alignment with one of the first and second mating tongues in said vertical direction.

20. The electrical connector as claimed in claim 19, wherein said another seam structure is configured with a full dimension of the corresponding mating tongue in the mating direction while said seam structure is configured to have a dimension similar to the distance in the mating direction.
